(19) United States
(12) Patent Application Publication
(10) Pub. No.: US 2004/0111950 A1
(43) Pub. Date: Jun. 17, 2004

(54) Under water lighted fishing lure

(76) Inventor: Peter B. Lindgren, Pompano Beach, FL (US)

Correspondence Address: ROBERT C. KAIN, JR., 750 SOUTHEAST THIRD AVENUE, SUITE 100, FT LAUDERDALE, FL, 333161153

(21) Appl. No.: 10/682,501

(22) Filed: Oct. 9, 2003

Related U.S. Application Data
(63) Continuation-in-part of application No. 10/328,889, filed on Dec. 23, 2002.
Application No. 10/328,889 is a continuation-in-part of application No. 10/232,299, filed on Aug. 30, 2002.
Application No. 10/232,299 is a division of application No. 09/580,142, filed on May 30, 2000, now Pat. No. 6,481,148.
(60) Provisional application No. 60/157,821, filed on Oct. 5, 1999.

(51) Int. Cl. A01K 75/02

(52) U.S. Cl. 43/17.5

(57) ABSTRACT

The underwater lighted fishing lure utilizes a two-color lighted system (blue, green, blue-green, white) which either blinks two LEDs ON and OFF (cyclically or randomly) or includes laterally extending fins causing the underwater lighted fishing lure to spin or rotate due to current flows thereby flashing colors from a certain perspective underwater. Light emitting devices (LEDs) maybe driven with excess voltage or current (above 3.5 volts) by 2, 3 or 4 lithium batteries or 3 or 4 alkaline batteries. To modify the beam of light from the LEDs, light modifiers, light diffraction gratings and light reflection surfaces disperse the light laterally away from the elongated housing. Chemical lights of different colors with laterally extending fins are spaced apart to facilitate breakage and activation of chemical capsules. A clip system with a double spring action includes a U-shaped clip at an end of an O-shaped body.

The present application is a continuation-in-part patent application based upon and claiming the benefit of patent application Ser. No. 10/328,889, filed Dec. 23, 2002, now pending, which is a continuation-in-part patent application based upon and claiming the benefit of patent application Ser. No. 10/232,299, filed Aug. 30, 2002, now pending which is a divisional of patent application Ser. No. 09/580,142 filed May 30, 2000, now U.S. Pat. No. 6,481,148, issued Nov. 19, 2002, which was a regular patent application based upon provisional patent application Ser. No. 60/157,821 filed Oct. 5, 1999.

The present invention relates to an underwater lighted fishing lure and a method therefor.

Fishermen have used light for squid and bait fishing for many years. Simple lighted lures included a battery powered light disposed in a sealed glass jar. This evolved into a plastic incandescent light manufactured in Japan consisting of a clear two piece acrylic design with a single 1.5 volt AA battery powering a flashlight bulb at the top of the light. When the top of the Japanese light was screwed to the base, the battery made contact activating the light thus becoming the on/off switch. A single O-ring sealed the two halves to form a watertight seal when the light was activated. Chemical lights were then deployed to lure fish. See U.S. Pat. No. 3,576,987 by Voight; U.S. Pat. No. 5,067,051 by Ledyjensky; and U.S. Pat. No. 5,213,405 by Giglia.

Other lighted fishing lures are shown in U.S. Pat. No. 4,598,346 to Boddie (incandescent light with a ballast powered by 12 volt car battery); U.S. Pat. No. 5,070,437 to Roberts (LED light activated by flexing LED lead to engage the battery); U.S. Pat. No. 5,076,003 to Chen (transparent tubular chamber with light-emitting device powered by button type batteries with low miliamp hour life); U.S. Pat. No. 5,299,107 to Ratcliffe; U.S. Pat. No. 5,915,941 to Casey; and U.S. Pat. No. 5,983,553 to Gordon.

### OBJECTS OF THE INVENTION

The objects and advantages of the present invention, described herein and in other sections, include: providing an underwater, battery powered lighted fishing lure with different colored LEDs; a lure which spins or flashes different colors; a lure with LEDs driven at higher voltages and/or currents to emit greater amounts of light; a lure with different colored chemical lights; and innovative clip assemblies for these lights.

### SUMMARY OF THE INVENTION

The underwater fishing lure includes, in one embodiment, a transparent housing, batteries (typically two) and two light emitting devices (LEDs), wherein each LED emits a different color light. Studies have shown that the use of a two color LED lighted lure greatly enhances fish catch. Particularly, when the lure includes a blue LED and a green LED, fish catch is more than double a white LED lure, a blue green LED lure or green LED lure. Although not as dramatic, a green and white LED pair also significantly increases fish catch. In another embodiment, the pair of LEDs are driven with a voltage at or above 3.3 volts. Typically this is established with the use of a pair of serially connected lithium batteries. A further embodiment of the present invention drives the LEDs at or above 125% of the recommended drive voltage for the LED or 150% over the maximum current. Studies have also shown that driving LEDs at higher voltages or currents significantly increases fish catch. Over driving LEDs increases the light intensity or lux output of the lure. Blinking circuits or cycling each LED ON and OFF also improves the lure. Other circuits cycle one LED ON and OFF at a different rate compared to the other LED. To achieve the same feature (cycles or blinking), a battery powered lighting fishing lure, generally shaped as a cylinder, may include, at one terminal end, a planar wing extending axially wherein the planar wing is large enough to turn the lure based upon underwater flows and currents. Further, a chemical luminescent lighted fishing lure, also configured as a cylinder, may include a planar wing extending from the terminal end which causes the lure to twist, turn and rotate based upon underwater flows and currents.

Another embodiment of the underwater lighted fishing lure utilizes a two-color lighted system (blue, green, blue-green, white) which either blinks two LEDs ON and OFF (cyclically or randomly) or includes laterally extending fins causing the underwater lighted fishing lure to spin or rotate due to current flows thereby flashing colors from a certain perspective underwater. Both blinking and fins may be utilized in the same lighted fishing lure. Light emitting devices (LEDs) maybe driven with excess voltage or current (above 3.5 volts) by 2, 3 or 4 lithium batteries or 3 or 4 alkaline batteries. To modify the beam of light from the LEDs (typically, the LED beam is a narrow light beam), light modifiers, light diffraction gratings and light reflection surfaces disperse the light laterally away from the elongated housing (a semispherical light cone is formed). Chemical lights of different colors (blue+white, green+white or blue-green+white) with laterally extending fins are spaced apart to facilitate breakage and activation of chemical capsules. A clip system with a double spring action includes a U-shaped clip at an end of an O-shaped body. The clip may be used with either the chemical two-color light with fins or the battery powered two-color light.

### BRIEF DESCRIPTION OF THE DRAWINGS

Further objects and advantages of the present invention can be found in the following detailed description when taken in conjunction with the accompanying drawings in which:

FIG. 1 diagrammatically illustrates the underwater battery powered lighted fishing lure;

FIGS. 2 and 3 diagrammatically illustrate a partial, exploded view of the underwater battery powered fishing lure with the batteries extracted from one of the two body parts forming the housing, and an exploded view of primary components of one embodiment;

FIGS. 4A and 4B diagrammatically illustrate a side view of the outside of one body part (the main body) of the housing and another cam control system;

FIG. 5 diagrammatically illustrates the side arm of the other body part (the top) of the housing and a cam actuator member or finger;

FIGS. 6 and 7 diagrammatically illustrate an internal end view of the top body housing and a partial, cross-sectional view of the top body part;

FIGS. 7B and 7C diagrammatically show switch pin cam follower positions on cam surfaces (plan views of arcuate cam surfaces which generally correspond to FIGS. 4A and 4B, respectively);

FIG. 8 diagrammatically illustrates an internal end view of the top body part shown in FIG. 7;

FIG. 9 diagrammatically illustrates a basic electrical schematic for the lure (one LED, a battery and two switches);

FIG. 10 diagrammatically illustrates another electrical schematic for the lure (two LEDs, each of a different color;

FIG. 11 diagrammatically illustrates a representation of light refraction from the LED, LED cavity, battery cavity and housing and light reflection from the battery;

FIGS. 12A and 12B diagrammatically illustrate, in block diagram form, basic electric circuits for the two color fishing lure, with and without a blinking or cycle ON and cycle OFF circuitry;

FIGS. 13A, 13B, 13C and 13D graphically illustrate increases in fish catch based upon a two color fishing lure, the increase in light output of the fishing lure, the general relationship between voltage of the battery supply and the light output, and the current (mA) versus voltage (v) for various LEDs, respectively;

FIGS. 14A and 14B diagrammatically illustrate the planar wing extension which enables the fishing lure to twist or rotate thereby mechanically simulating a blinking or cycle ON and OFF fishing lure and a two-color chemical light fishing lure;

FIGS. 15A, 15B, 16A and 16B diagrammatically illustrate two color chemical fishing lures and a clip for a lure (FIG. 16B);

FIGS. 17A-17C diagrammatically illustrate the housing for a four battery LED lighted fishing lure; and FIGS. 18A, 18B and 18C graphically illustrate the significant increase in fish catch (measured in catch per unit effort—CPUE) for two color LED fishing lights compared with a mono-color chemical light and the significant increase in fish catch using optic enhancements in the light housing and fin extensions (4 battery, two colored light system) compared to a simple 4 battery, two colored LED lighted lure.

### DETAILED DESCRIPTIONS

The present invention relates to a lighted fishing lure and method therefor.

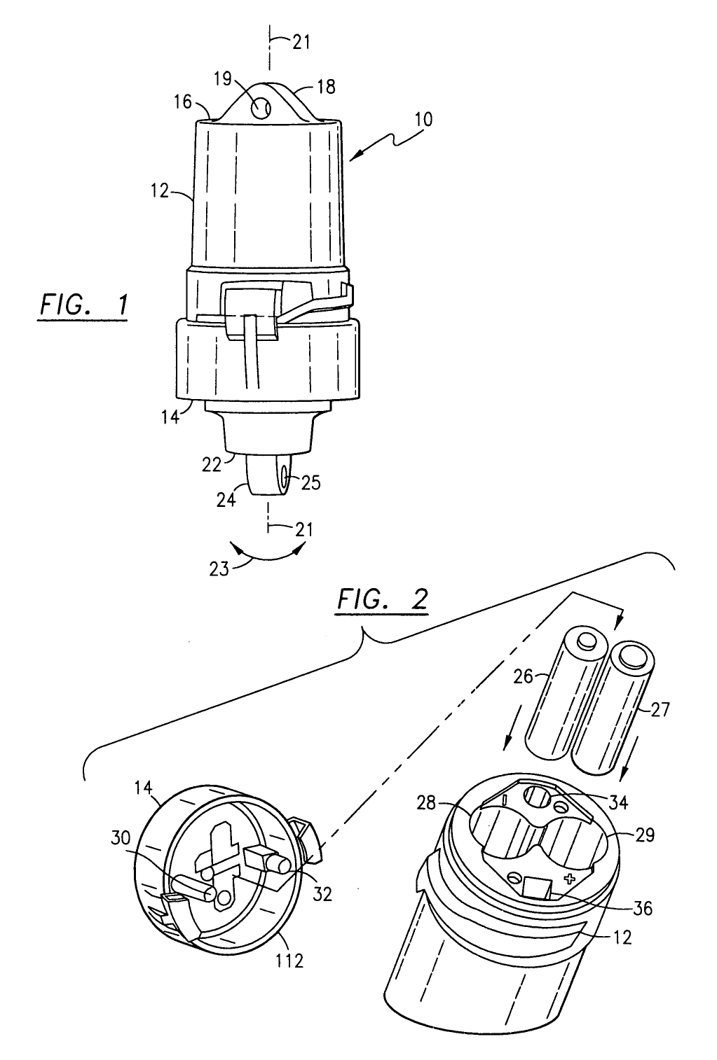

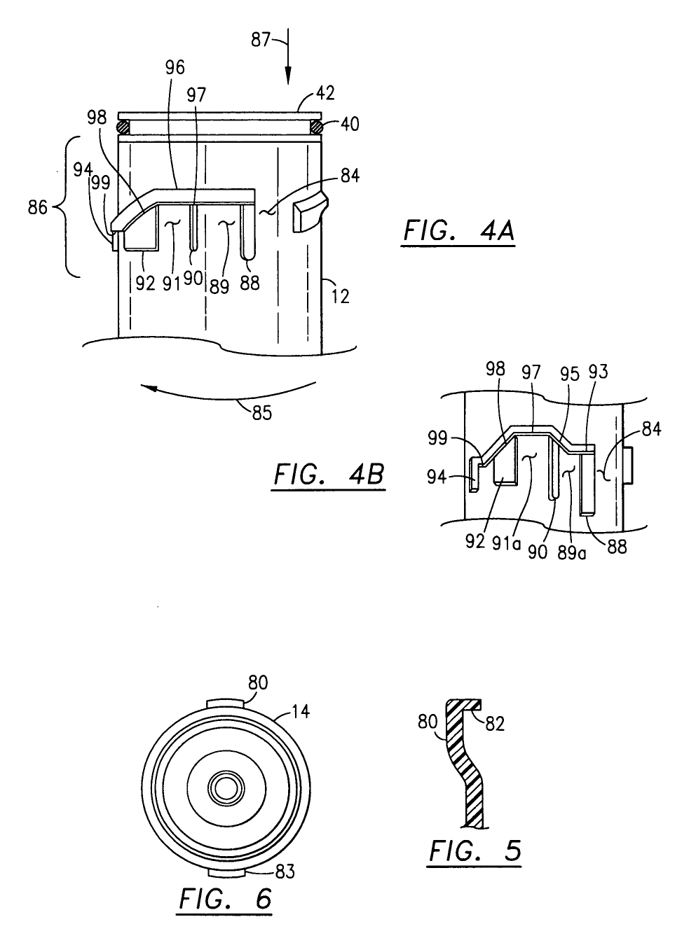

FIG. 1 diagrammatically illustrates lighted fishing lure 10 having a first body part 12 which is removably attached to a second body part 14. First body part 12 has an end face 16 with an axially protruding member 18. Axially protruding member 18 (see axial center line 21) includes a hole 19 therethrough which enables lighted fishing lure 10 to be attached to a longline fishing line. Lure 10 is generally cylindrical (FIG. 1) or frusto-conical in shape (FIG. 11). Second body part 14 includes end face 22, axially extending member 24 and eyelet 25 for fish line attachment. Body parts 12 and 14 rotate with respect to each other (see arrow 23). When rotated to a release position or an OPEN (FIG. 4A), body part 14 is axially withdrawn from body part 12 and access to batteries 26, 27 is provided. Other battery shapes may be utilized but cylindrical AA batteries currently used.

FIG. 2 diagrammatically illustrates a partial, exploded view of the light showing body part 14 withdrawn from part 12 and batteries 26, 27 removed from cavities 28, 29. LEDs 30, 32 extend into LED cavities 34, 36 formed in body part 12. The base 30a (round), 32b (squared) of each LED 30, 32 is shaped to conform to a particular cavity 36, 34 in body part 12 thereby ensuring that the operator correctly matches the polarity of batteries 26, 27 and the circuitry. The lighted fishing lure utilizes a light emitting device which, in one embodiment, is a light emitting diode or LED. LEDs were selected because those devices emit light based upon electrical excitement of their elements, are low voltage level devices, are highly efficient light generators and do not generate heat. Further, LEDs are highly durable when used in the very adverse conditions of the present fishing lure. The LEDs of the present invention are not incandescent devices or fluorescent devices or devices which include tungsten filaments. Similar numerals designate similar items throughout the figures.

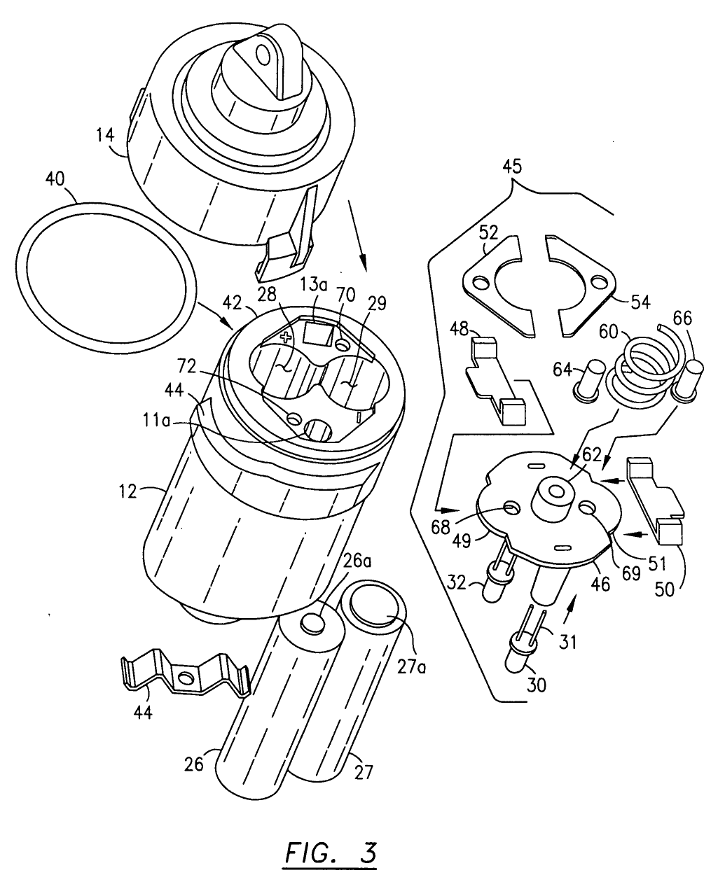

FIG. 3 diagrammatically illustrates an exploded view of the light. An O-ring 40 is mounted in groove 42 on end region 42 of body part 12 and creates a watertight seal between body parts 14,12. The O-ring seals the lighted lure during ON, AUTO (pressure sensitive mode) and OFF control modes. Batteries 26, 27 are placed in cavities 28, 29 and opposing battery terminal ends are adjacent each other. Contact plate 44a is disposed at the internal end (not shown) of cavities 28, 29 to connect the positive and negative terminals of the two adjacent batteries. Body part or cap 14 retains LED circuit elements 45 which transfer electrical power from batteries 26, 27 to LEDs 30, 32. This circuit includes an insulated base 46, battery terminal members 48, 50 and circuit connectors 52, 54. Battery terminal members 48, 50 are placed on end regions 49, 51 of plate base 46. Terminals 48, 50 include U-shaped spring members which contact battery terminals 27a, 26a of batteries 26, 27. These U-shaped spring terminals are diagrammatically illustrated as disposed in cap body part 14. Insulating platform 46 is spring loaded in the interior of cap 14 via coil spring 60. Coil spring 60 rides on post 62 extending above platform 46. Loosely retained pins 64, 66 are mounted in through passages 68, 69 which limit the side to side or rocking movement of floating platform 46. Conductive elements 52, 54 close the electrical circuit formed by batteries 26, 27, conductive plate 44, battery terminals 48, 50, conductive plates 52, 54 and the electrical leads (one of which is lead 31) extending from LEDs 30, 32 when the system is ON. Body part 12 includes cavities 70, 72 which hold hydrogen absorbing pellets. In one embodiment, hydrogen absorbing pellets known as “getters,” are placed in cavities 70, 72.

FIG. 4A diagrammatically illustrates body part 12 having a plurality of cam surfaces thereon. FIG. 5 illustrates side arm 80 (FIG. 6) of cap 14 having a cam actuator surface or finger 82. FIG. 6 is an end view of body part or top 14 showing side arms 82, 83. In order to place cap body part 14 on main body part 12, side arm 80 and particularly cam actuator finger or surface 82 is axially aligned with flat land area 84 (FIG. 4A) on the generally cylindrical end region 86 of main body part 12 and body part 14 is axially moved (see arrow 87) onto main body part 12. Body part 12 has slightly raised lands 88, 90, 92. Extreme rotational movement in the direction shown by arrow 85 is prohibited due to radially extending stop 94. A flat lands 89 and 91 (on the cylindrical surface) are defined between slightly radially raised lands 88, 90 and 92. Cam actuator finger 82 (FIG. 5) moves over raised lands 88, 90 and 92 to rotational stop 94. Raised lands 88,90 provide tactile responses for the operator to locate OFF, AUTO ON and FULL ON positions.

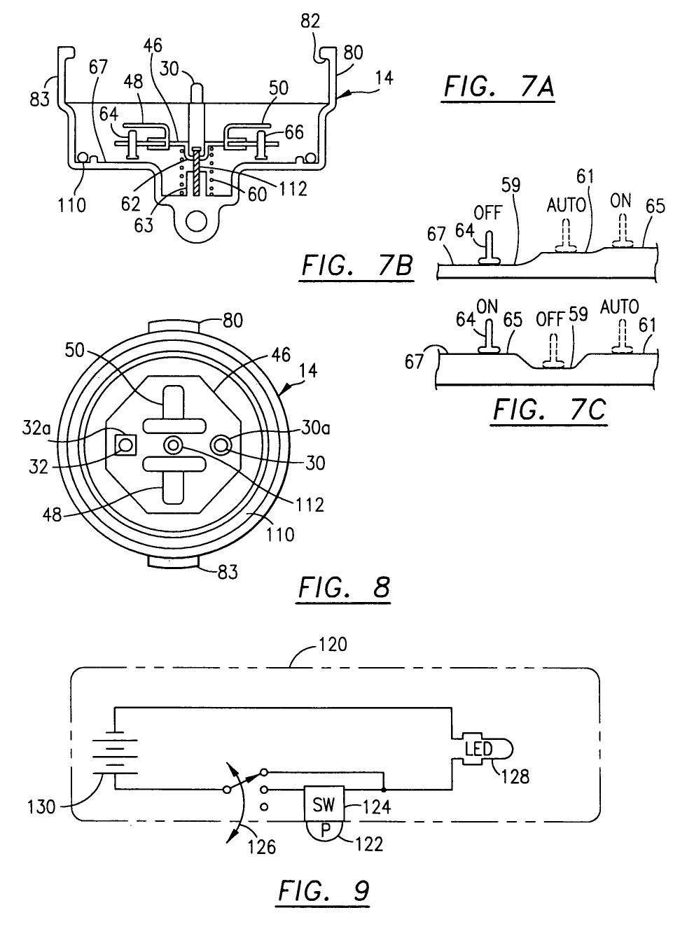

When finger 82 is in flat land 89, the LEDs are OFF; when in flat land 91, the fishing lure is in an AUTO ON or pressure sensitive control mode. When finger 82 is placed on slightly raised land 92, cap 14 is axially compressed and drawn to main body part 12 by axial slope 98. This reduces the axial length of the battery chambers or cavities and rotates pin 64 (FIGS. 7A and 7B) from low cam surface 59 to intermediate cam surface 61. In an OFF position, the batteries “shake” or are loosely retained in the cavities and do not simultaneously contact upper contact 44a and battery terminals 48, 50 because pins 64, 66 (FIG. 7A) do not force contact plates 48, 50 into contact with the battery terminals. Therefore, there is no closed electrical circuit. However, when cam actuator finger 82 is placed on land 92, cap 14 and body part 12 are still permitted to axially compress thereby forming a pressure sensitive control surface or surfaces and establishing a pressure sensitive switch. Pins 64, 66 are disposed on intermediate cam surfaces, e.g. pin 64 on surface 61 in FIG. 7B. The lighted fishing lure is designed such that, when the lure in the AUTO or pressure sensitive control mode, the system turns ON the LED or LEDs when the lure is approximately 10 feet or 3.0 m underwater. The pressure at this depth compresses cap 14 and body part 12 together thereby reducing the axial size of battery cavities 28, 29, causing the batteries to simultaneously contact upper and lower battery terminals due to pins 64, 66 acting on contacts 48, 50 and establishing a closed electrical circuit when the water pressure exceeds the predetermined level. The lighted lure is constructed to withstand about 1,000 psi (about 2,300 feet below sea level). Mechanically, a ridge or lip 96 (FIG. 4A) protrudes radially from main body part 12 and defines cam surfaces 97, 98, 99 which co-act with the cam actuator finger 82. When cam actuator finger 82 is acting on cam surface 97, the fishing lure light is OFF; when acting on axially sloped cam surface 98, the pressure sensitive switch is set to AUTO and the LEDs are turned ON or OFF based upon the ambient pressure underwater. Rotation of cap 14 with respect to body 12 causes pins 64, 66 to ride up on land 61 (FIG. 7B). In the third control mode (always ON), cam actuator finger 82 rides on cam surface 99 which establishes the maximum foreshortened position of top 14 with respect to body cap 12 and hence the maximum foreshortened position of the battery cavities 28, 29 and pins 64, 66 are raised by following cam surface 65 to their high up switch ON position (FIG. 7C). In this maximum foreshortened configuration, the LEDs are ON. The three way or tri-modal control of the lighted fishing lure is one of several important features of the present invention.

Another important feature of the present invention is to attach cap 14 onto body 12 in a bi-modal manner wherein, in the first mode when cam actuator finger 82 in is flat land 91 or raised land 92, the cap 14 is enabled to axially move with respect to body 12 based upon ambient pressure underwater. In a second mode of the removably attached, sealed, bi-modal configuration, axial movement of body part cap 14 with respect to main body part 12 is prohibited. This all ON mode is established when cam actuator finger 82 abuts and locks unto cam surface 99 (FIG. 4B) which is axially inboard with respect to cam surface 97. Limit lip 94 prohibits further movement of finger 82. The cam actuator system (OFF, AUTO ON and FULL ON) can be internal or external with respect to the housing (shown externally). Also, the cam surfaces can be disposed on part 12 or part 14, i.e., reversed. FIG. 4B shows a different exterior cam system with AUTO or pressure sensitive switch region at flat land 89a, OFF at flat land 91a and ON at the intermediate raised land 92 and end stop 94.

FIG. 7A shows a partial, cross-sectional view of end cap 14 and the electrical circuit 45 of LEDs 30, 32; FIGS. 7B and 7C show plan operational views and FIG. 8 shows an end view of the cap. Insulating platform 46 rides on spring 60 in the interior of cap 14. A spring loaded ride is caused by spring 60 loosely mounted on post 63 in the interior of cap 14 and post 62 depending from platform 46. A screw or other attachment 112 adjusts the degree of spring loading or float of platform 46. Platform 46 rotates on spring 60 due to keys 30a, 32b, and keyways 11a and 13a in main body housing 12 (see FIG. 3). Loosely retained cam follower pins 64, 66 are disposed axially beneath the U-shaped battery terminals 48, 50 to ensure that when pins rotate over cam surface 67 (see FIG. 7B), the pins force contacts 48, 50 upward to close the switch. Pins 64, 66 are loosely retained in holes 68, 69. See FIG. 3. The distal ends of floating pins 64, 66 are slightly flared such that the pins rotate over arcuate cam surface 67 as the platform 46 rotates with respect to end cap 14 and surface 67. An additional O-ring 110 is disposed in an appropriate channel or groove in the internal end face of top 14. O-ring 110 is compressed by edge 112 (See FIG. 2) of the main body part. Accordingly, two watertight seals are provided for the lighted fishing lure. O-ring 110 is primarily effective in the AUTO ON control mode when the pressure exceeds the predetermined level underwater or when the system is manually turned FULL ON. FIG. 8 diagrammatically illustrates an interior end view of top cap 14, battery terminals 48, 50, LEDs 30, 32 and the radial, outboard flare or U-shape of terminals 48, 50. LED bases 30a, 32a are keyed to internal keyways 11a, 13a (FIG. 3) such that (i) platform 46 (FIGS. 7A and 8) is interlocked with main housing 12 (FIG. 3) in only one position; (ii) the electronic circuit is established in a singular manner (if two LEDs of different color are used, resistors are typically required to balance light output from the LEDs); and (iii) platform 46 rotates based upon rotation of housing 12 with respect to cap 14.

FIGS. 7A and 7B are plan representations of arcuate cam surfaces on interior surface 67 of end cap 14. As pin 64 rotates due to linkage between platform 46 and housing 12 (see key and keyway sets 30a-11a and 32a-13a), the pins 64, 66 move over cam surface regions 59, 61 and 65 which move pins 64, 66 upward to strike contacts 48, 50 and close the electrical circuit with batteries 26, 27. At low level 59, the pin 64 does not force contact 48 into an electrical connection with the battery. The system is OFF. At intermediate cam surface 61 (AUTO ON), the pin 64 forces contact 48 to connect with the battery if underwater pressure on the system compresses the battery cavity the requisite degree to foreshortens the cavity, and closes the switch system. At high cam surface 65, the switch is closed (FULL ON) due to pin 64 contacting element 48 and making an electrical connection. FIG. 7C shows the complementary switch cam surface with high cam surface 65 (ON), low cam surface 59 (OFF) and intermediate cam surface 61 (AUTO or pressure sensitive).

It should be noted that various switch cam systems may be utilized within the scope and spirit of the present invention. For example, cam surface may be defined on the outboard side or underside of contacts 48, 50, the contacts could be arcuate and a cam actuator (e.g., rod) could be fixed on end cap 14 protruding from inboard surface 67 to the underside of contacts 48, 50. The height of the cam surfaces on the underside of arcuate contacts 48, 50 may determine switch control ON, OFF or AUTO. The key and keyways, e.g., 30a-11a, may be any shape, e.g., oval.

In one current embodiment, a two position or bimodal switch is utilized. This achieved by eliminating the permanently OFF switch setting established when finger 82 is in flat land 89. When the fisherman desires to turn OFF the lighted fishing lure, the lure cap is rotated with respect to the body such that finger 82 is disposed in flat land 91 (AUTO ON—pressure sensitive control position or mode) and when the lure is out of the water, the light is OFF. When the fishing lure is in the water beneath a predetermined depth, typically 5-10 meters, the lighted fishing lure automatically turns ON due to the pressure compressing the cap and body of the lure in an axial direction thereby closing the electrical switch connection due to the underwater pressure at the designated depth. To turn FULL ON, the fisherman further twists or rotates cap 14 over body 20 such that the finger 82 is adjacent FULL ON cam surface 99.

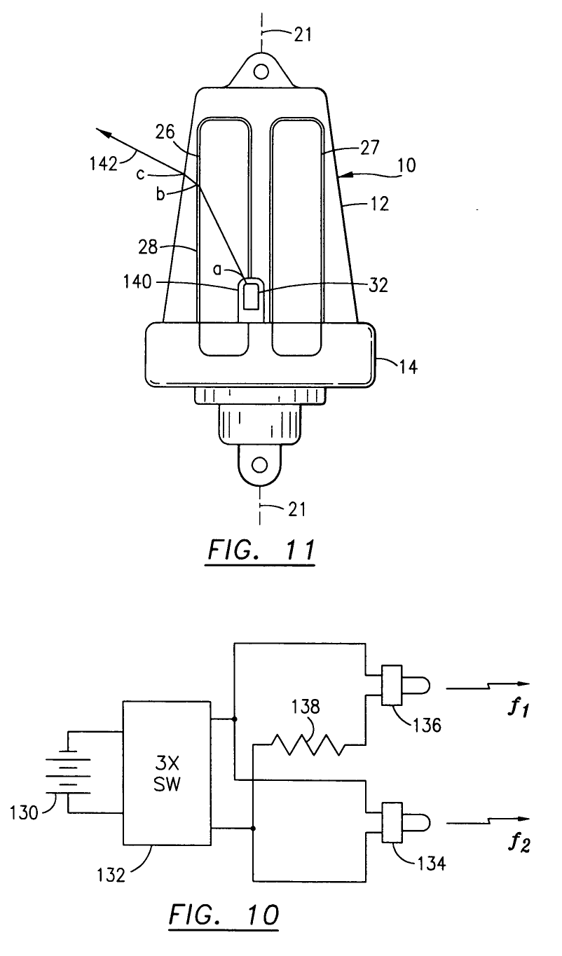

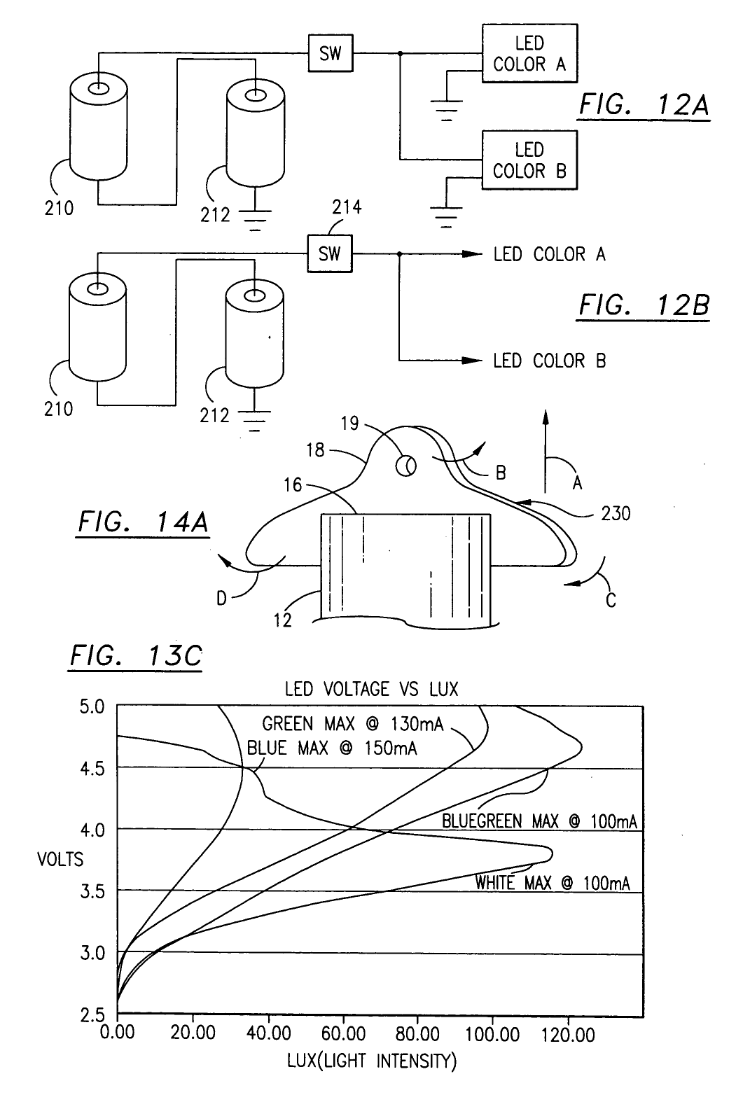

FIG. 9 diagrammatically illustrates an electrical schematic. The electrical components are mounted in a housing shown by dashed-dot-dashed line 120. Housing 120 seals the entire electrical system except pressure sensitive surface 122 associated with switch 124. Another switch 126, is a three position switch which turns the LED 128 ON (the system condition shown in FIG. 9) or enables the pressure sensitive switch 124 to control the LED (AUTO ON) or turns the system OFF. Battery 130 completes the electrical circuit. In one embodiment, two batteries are utilized and two blue Nichia LEDs 30, 32 are utilized with no other resistive elements in the circuit. Green Nichia LEDs are also useful. However, the system can be configured with a single LED 128 and a single battery 130. The system may include resistors to match the voltage to the LED. Other power conditioning circuit elements maybe used. However, additional electrical components reduce power available to the LEDs. The tri-state switch with ON, OFF and pressure sensitive ON states is an additional feature of the present invention. The pressure sensitive switch 124 must have a pressure sensitive control surface exposed to the ambient environment of housing 120. In a working embodiment, (1) manual switch 126 is provided by the rotational movement of top 14 with respect to body 12; (2) pressure sensitive switch 124 is provided by cam actuator finger 82, land 92, axially inboard sloped cam surface 98 which enables the pressure in the ambient underwater environment to axially compress cap 14 with respect to body 12 and foreshorten battery cavities 28, 29, and the switch cam system (FIG. 7B) which moves contacts 48, 50 close to the batteries until batteries 26, 27 make electrical contact with both conductor plate 44 and battery terminals 48, 50; and (3) the full ON position switch is provided the cam fingers pulling the two housing bodies axially together, thereby foreshortening the entire housing and forcing pin contacts toward the batteries 26, 27 such that the batteries make electrical contact with plate 44 and terminals 48, 50. FIG. 9 shows a simple electrical schematic with battery 130, three position switch 126, pressure sensitive switch 124 with pressure sensitive surface 122 and LED 128. It should be noted that other types of switches may be utilized rather than the simple combined ON/OFF switch and pressure sensitive switch (AUTO) described in the current embodiment. A mechanical slide switch (properly sealed) could be placed on the housing 10 (FIG.1) thereby providing the function of switch 126 in FIG. 9. Many pressure sensitive switches 124 can be utilized to enable the pressure sensitive control for LED 128. One example is a bladder actuated pressure switch. Singular or multiple LEDs may be incorporated into the present invention. Resistors may also be used but power consumption is a factor.

FIG. 10 is an electrical schematic showing battery 130, a three-way switch 132 and LEDs 134, 136. Three way switch 132 represents the ON, AUTO and OFF switch. LED 136 emits a light of one color or frequency F1 and LED 134 emits a different color light having a different frequency F2. A resistor 138 is disposed between LED 134 and 136 in order to reduce the voltage and equalize the light output from LED 136. A series of tests using different colored LEDs have established that different colored LEDs produce intensities of light. The intensity of light is measured as a Lux factor. Resistor 138 is sometimes required in order to somewhat equalize the light output of LED 136 as compared with LED 134. In one embodiment, two LEDs are utilized, each having the same color and frequency.

Generally, an LED emits light as a forward directed beam. Preferably, the lure should emit light in substantially all directions to attract fish, that is, forward, aft and 360 degrees about its axial centerline. To this end, the optical characteristics of the fishing lure were improved. In one embodiment, the lure emits light with refraction, reflection and sometimes diffusion.

FIG. 11 diagrammatically shows lighted fishing lure 12 having an LED 32 and batteries 26, 27. Housing 10, consisting of body 12 and body or cap 14 is clear plastic. However, body 12 has an LED cavity 140 which enables refraction (due to the different densities) of an LED light beam 142 at the interface between cavity 140 and the transparent plastic of body 12. Beam 142 is refracted at both sides of the cavity wall. Upon exiting body 12, the beam is again refracted at the housing wall. Beam 142 is refracted at points a, b and c in FIG. 11. Accordingly, the shape of lighted fishing lure 10 is designed to refract the multitude of generally forward directed light beams from LED 32. Hence, the frusto-conical shape of body 12 and the LED cavities and the battery cavities increase light refraction. There is a plurality of LED light beams in addition to light beam 142 emanating from LED 32. FIG. 11 also diagrammatically shows light reflection from battery 27. Light beam 150 is reflected from battery 27 due to a light reflective surface on the battery. The light reflective surface is silver or mirror or mirrored film or white. Coating the battery cavity achieves the same result.

Tests have shown significant variations in light output from LEDs emitting different colored light and LEDs from different manufacturers. The output for the same color LED from different manufacturers and the light output from different colored LEDs varies from 3.1-13.52 for blue, 12-52 for green, and 6.4-12.80 for a combination blue-green LED.

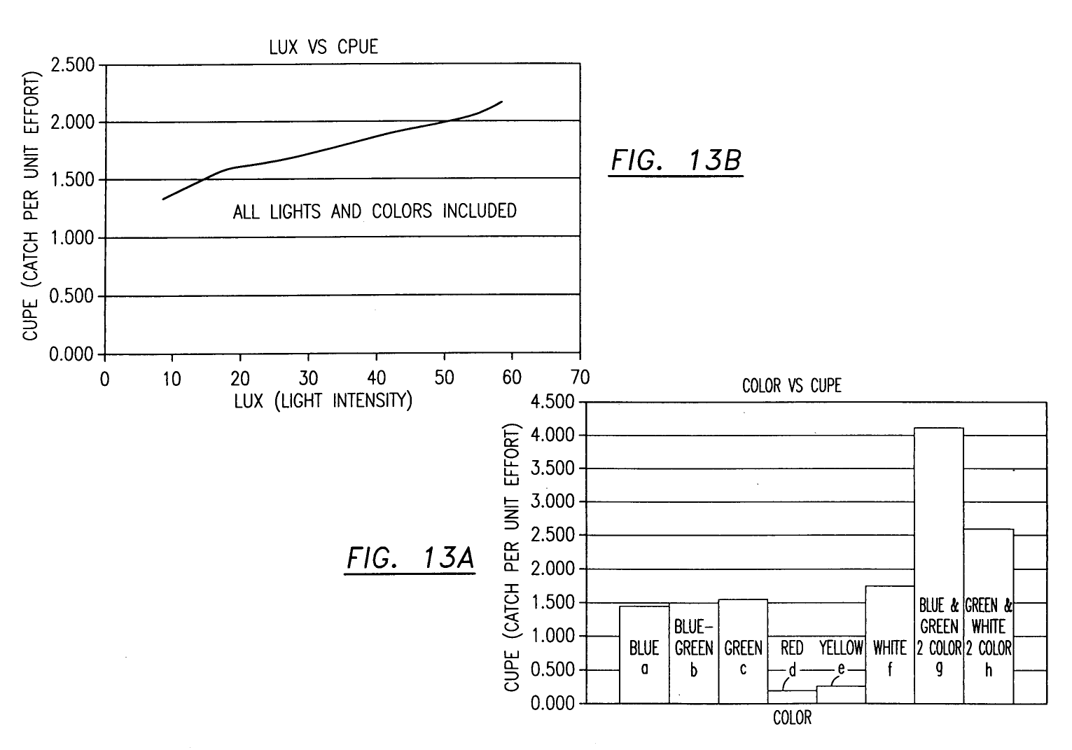

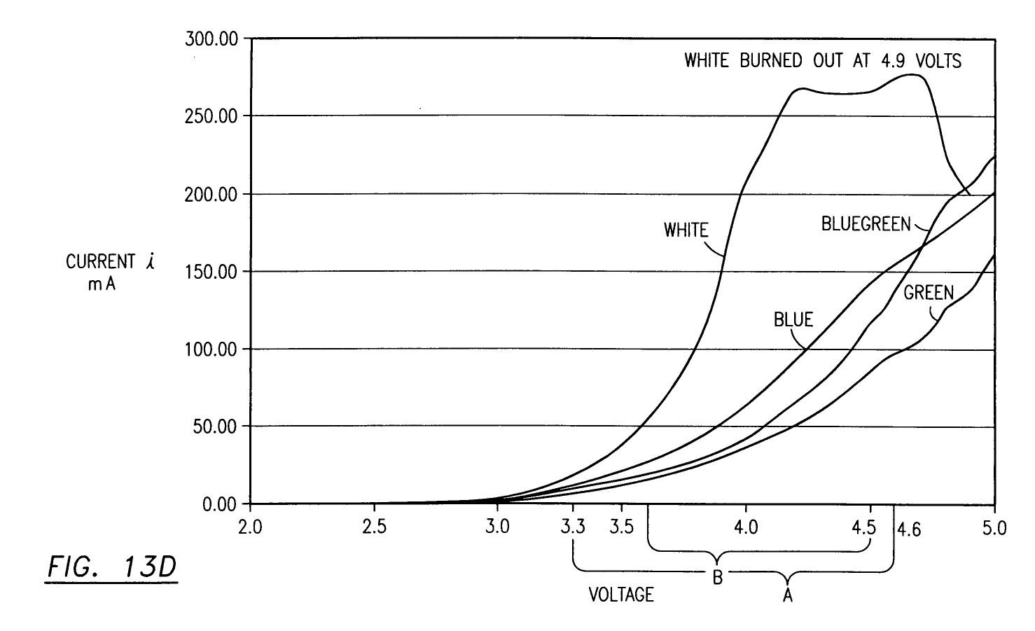

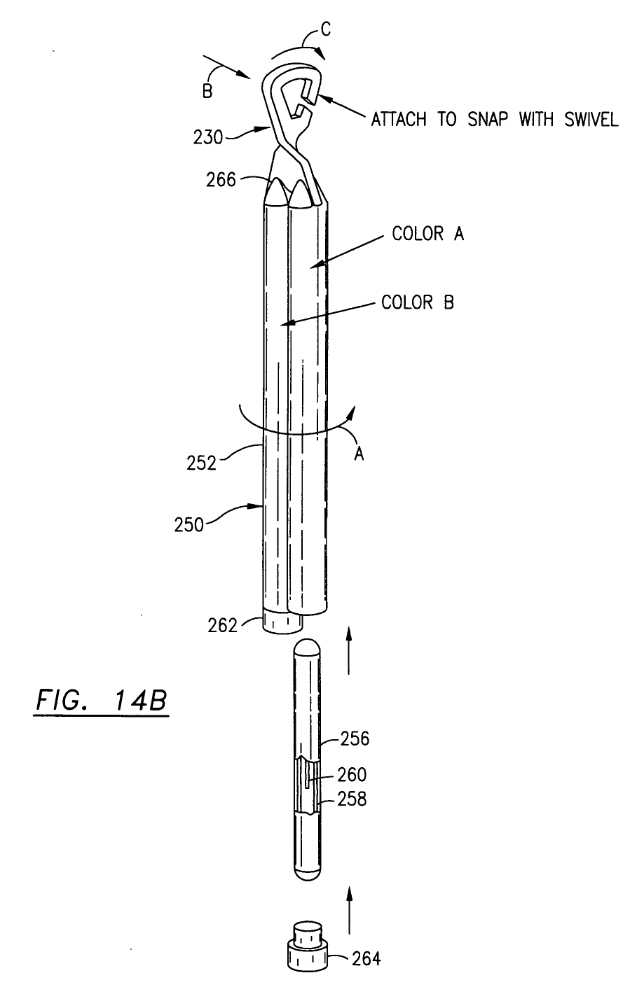

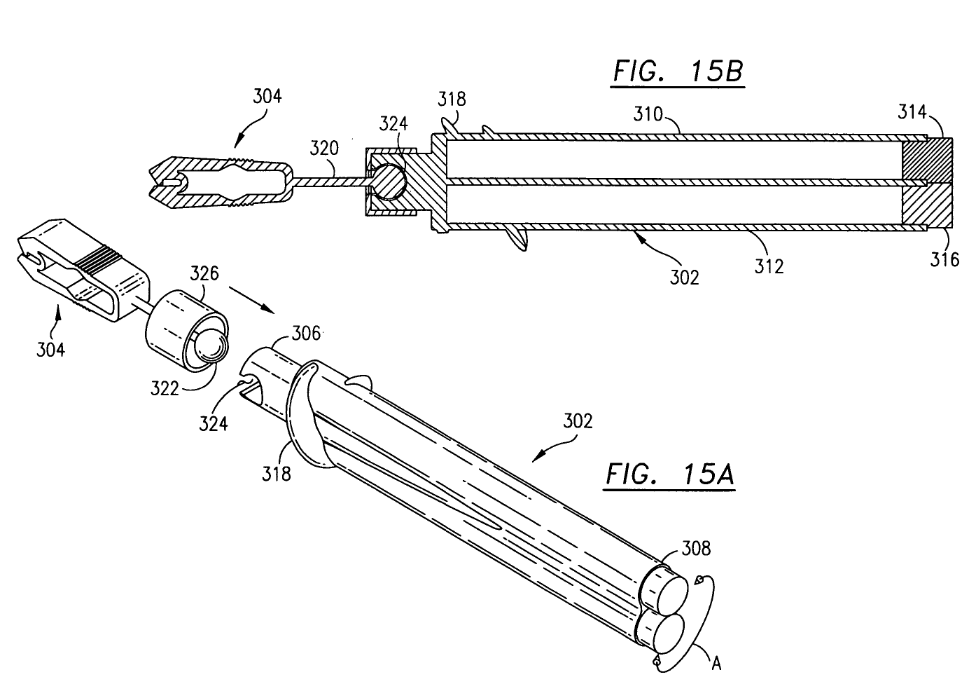

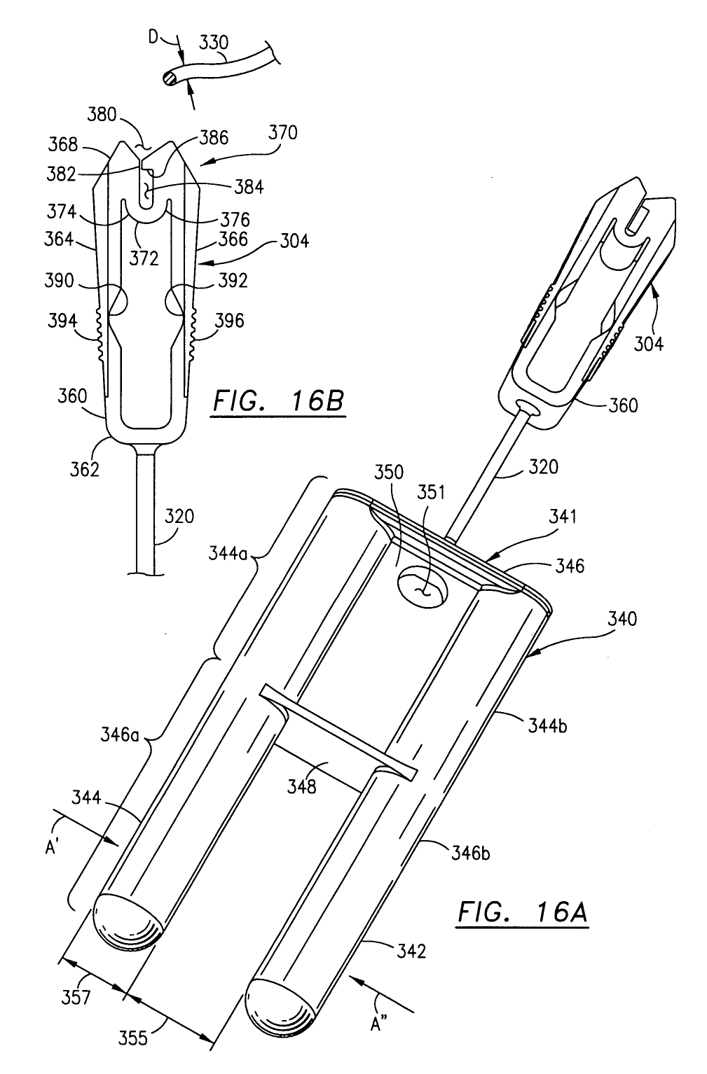

FIGS. 12A and 12B diagrammatically illustrate, in block diagram form, a two color LED lighted fishing lure (FIG. 12A) and a two color lighted fishing lure driven by a blinking or cyclic ON/OFF switch (FIG. 12B). Studies have shown that lighted fishing lures emitting two different colored lights greatly increase the fish catch. FIG. 13A graphically illustrates the catch per unit effort (CPUE) and compares lures, each having two LEDs, generating: (a) blue light, region A in FIG. 13A; (b) blue green light, region B; (c) green light, region C; (d) red light, region D; (e) yellow light, region E; and, (f) white light, region F (white light is a combination of many frequencies and is customarily considered a clear or non-colored light). These studies were conducted with multiple fishing boats in the same region over generally the same period of time. The blue, blue green, green and white fishing lures have two LEDs, each LED having the identical color light output. FIG. 13A graphically shows that red (d) and yellow (e) perform poorly in catching fish and blue, blue green, green and white colors (regions a, b, c and f) generally result in substantially the same catch per unit effort. Catch per unit effort (CPUE) is generally considered to be an acceptable standard which relates the total weight of the fish caught by the boat, total number of hooks fished multiplied by the number of days or nights the entire fishing rig or long or long line was deployed. If a fisherman deploys one hundred (100) hooks for five (5) days or nights (five different deployments, not necessarily associated with a daylight or nighttime period) and catches one thousand (1,000) pounds of fish, is CPUE is two (2). CPUE 2 is 1,000 divided by 5×100. Remarkably and contrary to expectation, two color LED lures greatly enhance fish catch. Blue-green, region G in FIG. 13A, produces fish catch more than double and almost triple the fish catch for single color lures. For green-white (region H), fish catch is double for blue, blue green, green and white. These statistics were unexpected. Accordingly, one important discovery of the current embodiment is that the use of a fishing lure with one blue LED and one green LED significantly enhances fish catch. Further, when the fishing lure includes one green LED and one white or clear LED, fish catch is still significantly enhanced. It is believed that the combination of blue green light from one LED and white from the other LED would also significantly enhance fish catch.

FIGS. 18A and 18B are graphs showing test results for two-color LED systems (blue LED paired with green LED—bar A; blue LED and white LED—bar B; green LED and white LED—bar C) compared to 6 inch chemical light sticks or fishing lures. The two-color blue+green LED fishing light caught 166% more fish than the conventional 6 inch chemical lighted fishing lure; the two-color green+white LED battery light doubled the fish catch (a 100% increase) and the two-color LED light (blue+white LEDs driven by batteries) fished 66% better than the chemical lights. These studies were conducted independent of the studies reported in FIGS. 13A and 13B. FIG. 18B reports a study that the blue-LED+green LED battery light driven in an over voltage/current mode with lithium batteries fished about 50% better (a higher CPUE) than a single color chemical lighted lure; that a two-color chemical lighted lure fished about 25% better than the mon-color chemical light lure; and that the overdriven two-color LED lighted lure fished about 20% better than the two-color (blue chemical+green chemical) lure. FIGS. 14B and 15A, B and C, diagrammatically illustrate two-color chemical fishing lighted lures.

FIG. 13B graphically reports that driving the battery powered LEDs in an over-drive condition produces higher fish catch. This new discovery, regarding driving the LEDs above the recommended drive voltage (125% or more) or 150% or more over the rated current, shows a significantly increased fish catch. LEDs typically have a current rating of 20 mA. The LEDs are supplied with higher currents than recommended by manufacturers. FIG. 13B shows when the lux or lighting intensity of the fishing lure is increased, the catch per unit effort or CPUE increases in the neighborhood of 30-40%. However, there is a tradeoff in that driving the LED's at higher voltages (125%) and currents (150%) increases the probability of burnout and reduces the overall life of the LED. Therefore, studies have found that providing 3.3 volts or higher to the LEDs achieves a reasonable increase in fish catch. Voltages below 3.3 volts, or below the total series voltage supplied by a pair of alkaline batteries, does not significantly increase fish catch. Increased lux output per increasing voltages (and, consequently, rated currents) is show in FIG. 13C. Preferably, the LEDs should operate at above 3.4 v DC and below 4.0 v DC (a voltage level where light output per milliamp decreases). Power regulation, for example, by a resistor (FIG. 10) (other regulators may be used), may be employed. FIG. 13D shows the relationship between current and voltage. Region A is the “overdrive” region (from about 3.3 v. to about 4.6 volts) but the preferred region is region B (overdrive between 3.6 v. and 4.5 v). The rated current for thee LEDs is 20 mA. FIG. 12A shows batteries 210, 212 in series. Also, the use of AA lithium batteries, when coupled in series, generates a supply voltage of 3.6 volts or higher. Therefore, any pair of series connected AA lithium battery achieves significantly higher fish catch. Conversely, two serially connected alkaline AA never supply a voltage above 3.3 v. Hence, voltages above any pair of serially connected AA alkaline batteries drive the LEDs into the higher voltage/higher current ranges and greatly increase fish catch. The significant increases in fish catch by overdriving LEDs was unexpected. When three alkaline batteries are serially coupled together, the supply voltage typically exceeds 3.8 volts to 4.8 volts. Voltages below 3.3 volts are not considered to significantly enhance fish catch. See FIG. 13C. A similar overdrive relationship is established with current. Therefore, two AA alkaline batteries typically generating 3.23 volt output when coupled in series, is not considered to be significant to increase fish catch. It is known that the voltage output of all batteries drops during use and that these lighted fishing lures are ON during extended periods, such as overnight, and during repetitive periods (each night for 1-2 weeks). Alkaline AA batteries typically are rated at 1.5 v but usually measure 1.6 v. EVEREADY AA lithium batteries are rated 1.5 v. but measure 1.7 v. A pair of AA lithium batteries are rated 3.6 v. Therefore, two AA lithium batteries always generate a voltage/current supply which overdrives the LEDs and produces significantly higher fish catch.

FIG. 13C graphically illustrates the relationship between voltage and lux for certain LED colors. Further, studies have shown that driving the LEDs at 150% or higher than the recommended drive voltage or current also reasonably significantly increases fish catch. Typically, the manufacturer of the LED specifies a voltage or a current which should be applied to the LED. When the battery supply voltage meets or exceeds the recommended drive voltage or current by 150%, fish catch increases by a significant amount. The LED operation graphically displayed in FIG. 13C all have a 20 mA current rating. Driving these LEDs of 150% the rated amperage reduces the normal operating life (about 100,000 hours). The chart shows lux output with three (3) alkaline AA batteries with a maximum supply voltage of 4.8 v. The maximum current is shown on the graph. The use of three or more alkaline batteries also provides voltage/current overdrive to the LEDs.

In addition, the utilization of a blinking circuit or a cycle ON and OFF circuit for the two LED fishing lure may attract additional fish. FIG. 12B shows that switch 214 blinks ON and OFF first LED color A and then LED color B. Synchronized, periodic or random activation is contemplated. The electrical blinking circuit could cycle LED color A ON at one cycle and LED color B ON at another cycle or may have a random cyclic behavior (effected by current, voltage, temperature, etc.). The same blinking effect may be achieved physically (employing a mechanical stationary wing and using hydraulic underwater flows) by adding a planar, curved or spiral, radially extending wing. See FIGS. 14A and 14B, wing 230.

FIG. 14A shows a generally cylindrical body 12 for the lighted fishing lure. FIG. 1 generally illustrates the entire, generally cylindrical (more specifically, a truncated frustoconcial shape) lure. In FIG. 14A, cylindrical body 12 has a terminal end or end face 16. Further, axially protruding member 18 (FIG. 14A) is axially elongated in direction A such that it forms a planar extension or wing 230. The wing 230 may have fins which protrude radially outboard of the generally cylindrical body 12 of the lure. The wings, in one embodiment, are twisted or curved (such as a spiral) at the inboard ends in direction C and direction D which, in the illustrated embodiment, act as a propeller to twist the lure due to local hydraulic flows and the swivel connection at the extreme terminal end, customarily attached to the fishing line or leader. The surface area or size of the wing is substantial compared to the cross-sectional size of the lure along its longitudinal axis. Planar extension or wing at the terminal end 16 of the lure's cylindrical body is large enough to cause the housing 12 to turn due to underwater flows and currents generally illustrated by arrow B is FIG. 14A. As discussed earlier, hole 19 permits the fishing lure body 12 to be attached to a line, typically a long line fishing rig. A snap swivel is customarily used with hole 19 on planar extension 230. The mechanical-hydraulic turning of the lure mimics the electrical ON-OFF cycle.

FIG. 14B diagrammatically illustrates a chemical luminescent lure 250. Fishing lure 250 includes two hollow body tubes to 252 and 254 attached adjacent each other. The elongated generally cylindrical fishing lure 250 retains therein a pair of enclosed tubes, one of which is sealed tube or sealed tubular containment system 256. Retained within sealed tube 256 is another pair of tubes one of which is a breakable tube. Both interior tubes are disposed in sealing tube 256, that is, tube 258 and tube 260 contain chemicals therein and are sealed in sealing tube 256. When breakable tube 260 is broken open by manual twisting, bending or crushing, shown by arrow A in FIG. 14B, the chemicals in tube 260 mix with the chemicals in tube 258 and within the interior sealed tube 256. When mixed, these two chemicals generate chemical luminescent light (a well known lighted system). Cylindrical external tube 254 holds sealed tube 256. Tube 252, adjacent exterior tube 254, holds a similar sealed tube for retaining the two chemical carrying tubes, not shown in FIG. 14B. Both sealed tubes, one of which is tube 256, are retained within exterior tube containers 252, 254 via respective end caps 262, 264. End caps 262, 264 are sealed such that the contents of interior sealed tubes 256 cannot be released to the environment. Each tube 252,254 emits a different colored light when activated. The chemical luminescent fishing lure has a terminal end 266 and an attached axially elongated planar extension 230. When underwater currents or flows approach lure 250 in direction shown in the arrow B in FIG. 14B, lure 250 rotates as shown by arrow C (discussed in detail in FIG. 14A). From a single viewing perspective, this turning is viewed as a blinking ON and OFF, two colored, lighted fishing lure.

FIGS. 15A and 15B diagrammatically illustrate a two-color chemical luminescent lighted fishing lure 302 having a clip 304 attachable to fore end 306. Two-color chemical lighted fishing lure 202 is elongated such that the fore end 306 is proximate to the fishing line (not shown, but see line 330 in FIG. 16B) and a rear end 308 which is distal to fishing line 330 (not shown). Lighted fishing lure 302 includes two generally transparent elongated housing units 310, 312 (FIG. 15B) mounted side-by-side. Each housing unit 310, 312 includes a chemical luminescent light stick therein. One light stick emits color when activated ON and generates preferably blue, green, blue-green or white light and the other light stick in housing 312 emits a different color than light stick in housing 310, the different color being selected from the group consisting of blue, green, blue-green and white. Light sticks are inserted into terminal end 308 and retained therein by end caps 314, 316. The chemical luminescent light sticks are activated ON by mixing two chemicals. One chemical is contained in a first capsule 258 (FIG. 14B) and a second chemical is contained in a second capsule 260 (FIG. 14B) and the second capsule 260 is retained within the first capsule 258. To activate the chemical luminescent light, housings 310, 312 are typically bent in a lateral sense (by holding one end and placing a lateral force at the other end) to break the innermost capsule 260 (FIG. 14B) thereby causing the mixture of the first chemical in capsule 258 with the second chemical in the now broken capsule 260. As explained earlier, it has been discovered that a two-color fishing lure catches significantly more fish than a single color lighted fishing lure. Laterally extending fins 318 protrude laterally and particularly at an acute angle (a spiral) with respect to the generally elongated housing 312. The laterally extending fins (see also FIG. 14A) cause the lighted fishing lure to turn due to underwater current flows.

Clip 304 includes lanyard attachment 320 (typically made of the same plastic material as the body of clip 304) and lanyard 320 terminates in a ball 322. Ball 322 fits into socket 324 at the fore end 306 of lighted fishing lure 302. Cap 326 locks ball 322 into socket 324 thereby permitting fishing lure 302 to turn as shown by double headed arrow A in FIG. 15A due to underwater current flows acting upon lateral fins 318. Please note that lateral fins 318 can be formed in various shapes and sizes but must be large enough to be affected by current flows. When activated ON, the lighted fishing lure 302 twists and rotates in direction A based upon underwater current flows nearby generating flashing colors if the fishing lure is viewed from a single perspective underwater.

FIG. 18C graphically shows that lighted fishing lures which flash two different colors increase fish catch approximately 100 percent. This is a significant discovery regarding flashing or blinking two-color fishing lures. The two colors preferably are blue+white, green+white, blue-green+white. Blinking is created mechanically by the fins and current flows or electrically by a blinking circuit(s).

FIG. 16A diagrammatically illustrates underwater lighted fishing lure 340 which includes two, generally transparent, elongated housing units 342, 344. Each housing unit retains a respective chemical luminescent light stick therein as discussed above in connection with FIGS. 15A and 14B. Lighted fishing lure 340 includes a support rib structure 341 which joins housing units 342, 344 together in a spaced apart relationship. Support rib structure 341 includes, in the illustrated embodiment of FIG. 16A, a fore end plate or bar 346 and a mid-section plate or bar 348. Additionally, support rib structure 341 includes joining plate 350 which extends from fore end plate 346 to mid-section plate 348. Support plate 350 includes a hole or aperture 351 therein. Light stick housing units 342, 344 are mounted in a spaced apart relationship such that each housing unit includes a mounted end portion 344a, 344b and a free end portion 346a, 346b. Support rib structure 341 joins the light stick housing units 342, 344 in a spaced apart relationship along mounted end portions 344a, 344b. The free end portions 346a, 346b are not supported by support rib structure 341 nor any other mechanism. Hence, the free end portions 346a, 346b can be pushed or forced towards each other. When a lateral force is applied as shown by arrows A′-A″ on the free end portions, the tubes or housings bend, and the innermost capsules holding the second chemical break, thereby mixing the second chemical with the first chemical in the luminescent light sticks retained within housings 342, 344. Preferably, the spaced apart distance 355 between each housing 342, 344 is greater than the cross-sectional dimension 357 of a single housing. The spacing establishes a flexation region for the light sticks. The longitudinal extent of support rib structure 341 is based upon the flexibility of housings 342, 344 and the crush or break point of the innermost second capsule in the light sticks mounted in generally transparent housings 342, 344.

FIG. 16B diagrammatically illustrates clip 304 for attaching an underwater fishing lure to line 330. Clip 304 includes generally rectangular O-shaped body 360 (the cross-sectional shape) (see also FIG. 16A), having a base 362 attached to lanyard 320, opposing sides 364, 366 and a fore end 368. A U-shaped clip 370 is formed at fore end 368 of O-shaped body 360. The U-shaped clip includes base 372, opposing legs 374, 376, a mouth 380 and a throat 382, leading to a capture space 384. At least one tooth 386 is formed at throat 382 separating mouth 380 from capture space 384. Fishing line 330 has a cross-sectional dimension D. The lateral dimension of tooth 386 is at least one-half of the cross-sectional dimension D of line 330.

In operation, clip 304 has a double spring action which clamps onto line 330. The first spring action is created by the U-shaped clip 370 and particularly U-base 372 and U-opposing legs 374, 376. This clip action secures line 330 in capture space 384. The second spring action is provided by O-shaped body 360 and particularly O-base 362 and O-opposing legs 364,366. Hence, the line 330, when placed in capture space 384, has two spring action elements acting on it (the line) to maintain closure of tooth 386 and retain capture of line 330 in capture space 384. To facilitate placement of line 330 in capture space 384, the O-shaped body 360 includes stress relief channels 390, 392 on the interior side of the generally O-shaped body 360. To enhance grip, the outer surface of O-shaped body 360 includes tactile gripping grooves 394, 396. By depressing opposing sides 364, 366 of O-shaped body 360, the fore end 368 of clip 304 opens thereby moving tooth 386 away from the opposing side and opening the throat 382. Upon opening throat 382, the user moves line 330 into capture space 384. In one working embodiment, line 330 is larger than the lateral dimension of capture space 384 (the distance between legs 374, 376) hence the double spring action of U-shaped clip 370 and O-shaped body 360 operates to securely fasten the clip 304 onto line 330.

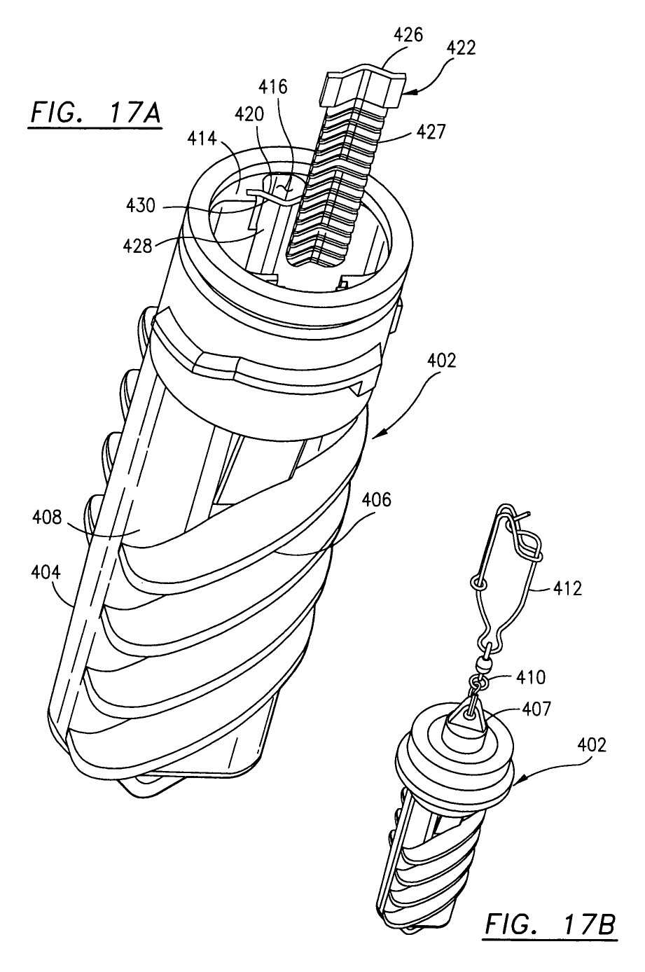

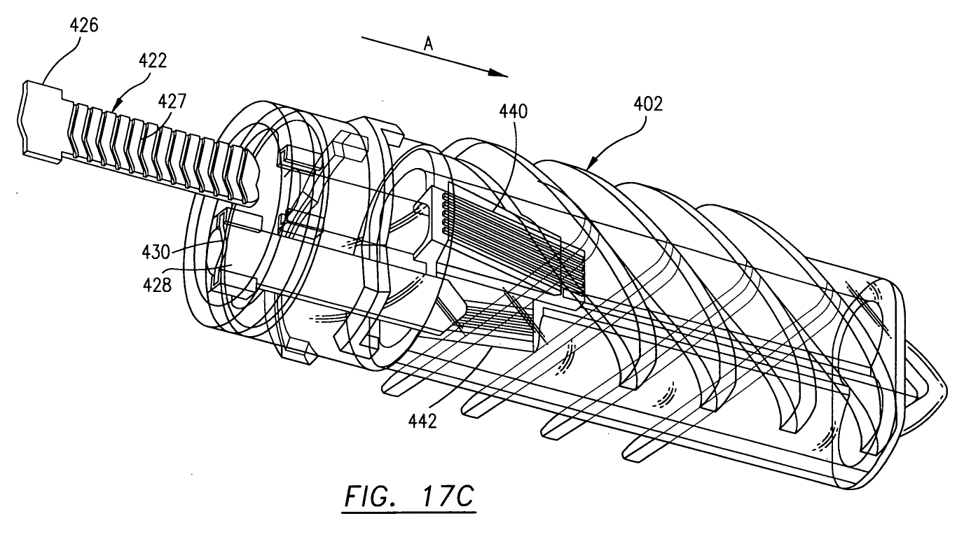

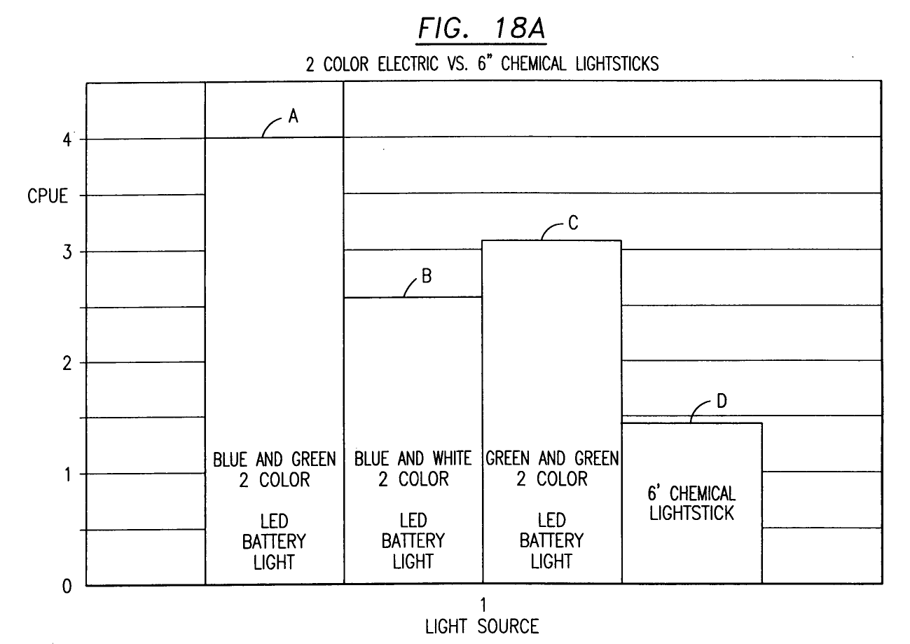

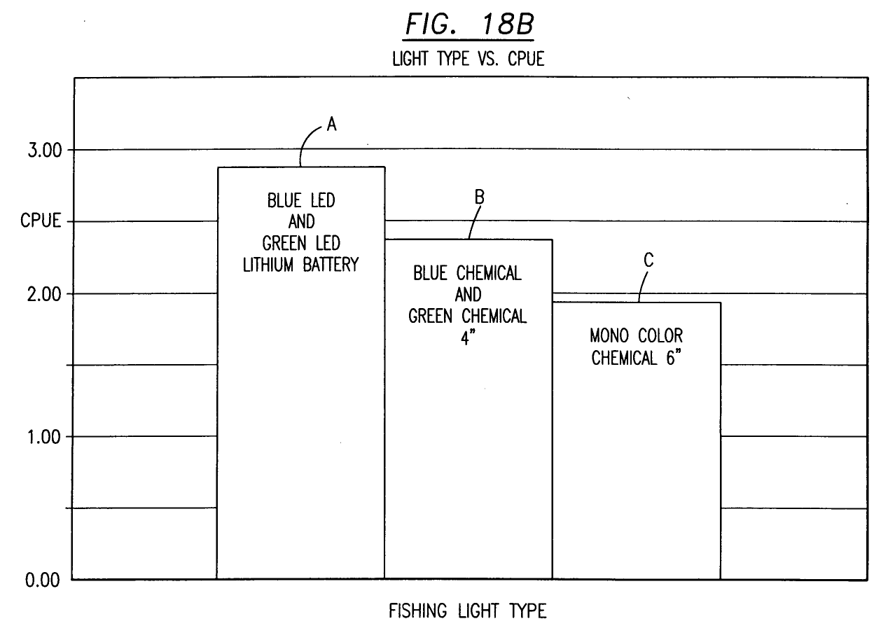

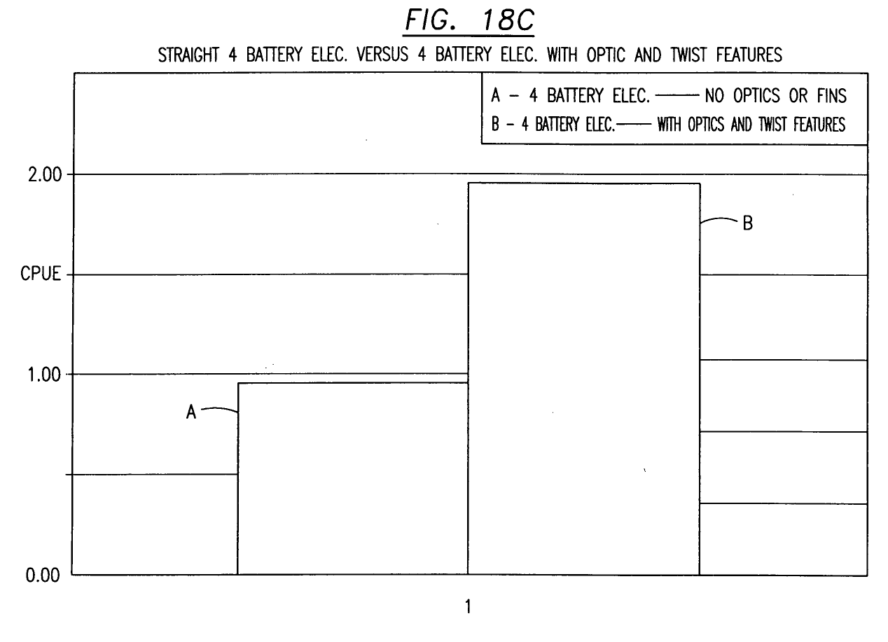

FIGS. 17A and 17B and 17C diagrammatically illustrate another battery powered lighted fishing lure 402. Lighted fishing lure 402 includes an elongated generally transparent housing 404 large enough to contain four batteries. A working embodiment of lighted lure 402 is a 4-battery system having an axial or longitudinal extent essentially double the longitudinal extent of the lighted fishing lure in FIGS. 1, 2 and 3. Different housing shapes may be used and the term “elongated” generally defines elements with respect to the longitudinal centerline of the body. Further, the lighted lure 402 can provide housing for 2-lithium batteries, 3-lithium batteries, 4-lithium batteries, 3-alkaline batteries or 4-alkaline batteries by design modification. Elongated, generally transparent housing 404 includes at least one, and as shown in FIG. 17A, multiple, laterally extending fins 406 (or a single, laterally extending, spiral fin). In addition, fins 406 are configured in a spiral about elongated, generally transparent housing 404. Further, a longitudinal fin 408 assists in permitting the two-color LED battery light 402 to turn thereby present flashing colors to fish underwater. The multiple position switch is included with the battery light 402 as discussed above in connection with FIGS. 1, 2, 3, 4A, 4B, 7A, 7B and 7C. Terminal end 407 (FIG. 17B) of battery powered light 402 is coupled to a common swivel mount 410 and a clip on system 412 is adapted to be clipped onto the fishing line. See fishing line 330 in connection with FIG. 16B. In the two-color LED battery light 402, the LEDs are disposed in spaces formed in housing wall 414 as defined by spaces 416. As discussed later in connection with FIG. 17C, battery light 402 includes one or more light modifiers and preferably includes both a light diffraction grating (discussed later in connection with FIG. 17C) and several light reflection surfaces 420, 422. Light reflection surfaces 420, 422 are established by an insertable panels, one of which is panel 426. Panel 426 is preferably a one-sided mirror and is generally clear but the backside 428 of panel 430 is either a mirror finish or white. Hence, light from the LED in space 416 passes through its respective panel 426 and is reflected from the opposing panel because opposing panel surface 428 is either a mirror finish or a white reflective surface or finish. Ribs 427 on panels 426,430 cause light from the respective LEDs to bend (diffract) thereby further diffusing the light from the LED. Light from the LEDs is generally emitted as a forwardly directed beam as shown by arrow A in FIG. 17C.

FIG. 17C shows that LED disposed in the space 416 (FIG. 17A) will emit light generally axially as a forwardly directed light beam in the direction A. Diffraction and reflection by panels 426, 430 scatter the light and change the light beam. Longitudinally beyond the LED in the line of sight beam path is a light diffraction grating 440, 442. Light diffraction grating further diffuses the light beam from the respective LED light.

FIG. 18C graphically illustrates that the four-battery, two-colored battery powered lighted lure is not as efficient in catching fish compared to a four-battery, two light fishing lure with light modifying optics and with lateral fins. The light modifying optics include the reflective plates 422, 430 and the diffraction gratings 440, 442. FIG. 18C, compiled after a study of fish catch, shows that the four-battery, two-colored light with light diffusing optics and lateral fins catches twice as much fish (100 percent CPUE increase) compared with a four-battery, two-colored light without the light modifying structure and without the lateral fins. As discussed earlier, the lateral fins cause the lure to be effected by underwater currents such that the lighted fishing lure spins or rotates thereby causing a fish to see a flashing, two-colored light. The light modifying elements, the reflective plate and the diffraction grating alter light which generally is emitted by the LED as a forward directed beam (direction A, FIG. 17C) and alters that beam and diffuses it to a range in an outwardly extending cone or a semi-hemispherical light beam rather than a downwardly directed, generally narrow beam. Further, the LEDs in the lighted fishing lure of FIG. 17C are in an over-driven state, that is, being supplied with a voltage in excess of 3.4 volts caused by more than 3-alkaline batteries or 2, 3 or 4 lithium AA batteries. Utilizing a blinking circuit (FIG. 12B) achieves the same increase in fish catch as utilizing lateral fins which cause the battery light in the two-color chemical luminescent light to spin or rotate.

The claims appended hereto are meant to cover modifications and changes within the scope and spirit of the present invention.

What is claimed is:

1. An underwater battery powered lighted fishing lure comprising:
a transparent housing retaining at least one battery and at least two light emitting devices (LEDs), each LED emitting a different color light when ON;
a switch system electrically coupling said battery and said two LEDs to turn ON and OFF said LEDs, said switch system including a blinking circuit to turn said two LEDs ON and then OFF either cyclically or randomly.

2. An underwater lighted fishing lure as claimed in claim 1 wherein one LED of said at least two LEDs emits a green light and the other LED emits either a blue light or a white light.

3. An underwater lighted fishing lure as claimed in claim 1 wherein one LED of said at least two LEDs emits a blue-green light and the other LED emits a white light.

4. An underwater lighted fishing lure as claimed in claim 1 wherein said lure is adapted to be placed underwater subject to underwater current flows, said housing being generally elongated, and laterally extending fins on or about said elongated housing, said fins affected by said underwater current flows.

5. An underwater lighted fishing lure as claimed in claim 1 wherein said at least one battery is a battery power source selected from the group of battery power sources including two lithium batteries, three lithium batteries, four lithium batteries, three alkaline batteries, four alkaline batteries, and any battery power source supplying power to said LEDs at a voltage at or above 3.4 volts.

6. An underwater lighted fishing lure as claimed in claim 1 wherein said at least one battery is two, three or four batteries, and said at least two LEDs each have a recommended maximum current, said at least two, three or four batteries supplying current to said at least two LEDs at or exceeding 150% of said recommended current.

7. An underwater lighted fishing lure as claimed in claim 6 wherein said two, three or four batteries are lithium batteries.

8. An underwater lighted fishing lure as claimed in claim 1 wherein said housing retains two batteries and said batteries provide a supply voltage at or above 3.4 volts for said at least two LEDs.

9. An underwater lighted fishing lure as claimed in claim 8 wherein one LED of said at least two LEDs emits a green light and the other LED emits either a blue light or a white light.

10. An underwater battery powered lighted fishing lure subject to underwater current flows comprising:
an elongated transparent housing retaining at least one battery and at least two light emitting devices (LEDs), each LED emitting a different color light when ON;
a switch system electrically coupling said battery and said two LEDs to turn ON and OFF said LEDs; and
laterally extending fins on or about said elongated housing, said fins affected by said underwater current flows thereby causing said lighted fishing lure to flash colors when said LEDs are ON due to said underwater current flows.

11. An underwater lighted fishing lure as claimed in claim 10 wherein one LED of said at least two LEDs emits a green light and the other LED emits either a blue light or a white light.

12. An underwater lighted fishing lure as claimed in claim 10 wherein one LED of said at least two LEDs emits a blue-green light and the other LED emits a white light.

13. An underwater lighted fishing lure as claimed in claim 1 wherein one LED of said at least two LEDs emits a green light and the other LED emits either a white light or a color other than green.

14. An underwater lighted fishing lure as claimed in claim 10 wherein said at least one battery is a battery power source selected from the group of battery power sources including two lithium batteries, three lithium batteries, four lithium batteries, three alkaline batteries, four alkaline batteries, and any battery power source supplying power to said LEDs at a voltage at or above 3.4 volts.

15. An underwater lighted fishing lure as claimed in claim 10 wherein said at least one battery is two, three or four batteries, and said at least two LEDs each have a recommended maximum current, said at least two, three or four batteries supplying current to said at least two LEDs at or exceeding 150% of said recommended current.

16. An underwater lighted fishing lure as claimed in claim 15 wherein said two, three or four batteries are lithium batteries.

17. An underwater lighted fishing lure as claimed in claim 10 wherein said housing retains two batteries and said batteries provide a supply voltage at or above 3.4 volts for said at least two LEDs.

18. An underwater lighted fishing lure as claimed in claim 17 wherein one LED of said at least two LEDs emits a green light and the other LED emits either a blue light or a white light.

19. An underwater battery powered lighted fishing lure comprising:
an elongated transparent housing retaining at least two light emitting devices (LEDs), each LED emitting a different color light when ON;
an electrical power source, retained within said housing, selected from the group of power sources including two lithium batteries, three lithium batteries, four lithium batteries, three alkaline batteries, four alkaline batteries, and any battery power source supplying power to said LEDs at a voltage at or above 3.4 volts; and
a switch system electrically coupling said batteries and said two LEDs to turn ON and OFF said LEDs.

20. An underwater lighted fishing lure as claimed in claim 19 wherein one LED of said at least two LEDs emits a green light and the other LED emits either a blue light or a white light.

21. An underwater lighted fishing lure as claimed in claim 19 wherein one LED of said at least two LEDs emits a blue-green light and the other LED emits a white light.

22. An underwater lighted fishing lure as claimed in claim 19 wherein said switch includes a blinker circuit which causes said at least two LEDs to blink ON and OFF.

23. An underwater lighted fishing lure as claimed in claim 19 wherein said lure is adapted to be placed underwater subject to underwater current flows, said housing being generally elongated, and laterally extending fins on or about said elongated housing, said fins affected by said underwater current flows.

24. An underwater lighted fishing lure as claimed in claim 19 wherein said at least two LEDs each have a recommended maximum current, said electrical power source supplying current to said at least two LEDs at or exceeding 150% of said recommended current.

25. An underwater lighted fishing lure as claimed in claim 22 wherein one LED of said at least two LEDs emits a green light and the other LED emits either a blue light or a white light.

26. An underwater battery powered lighted fishing lure comprising:
a transparent housing retaining at least one battery and at least two light emitting devices (LEDs), each LED emitting a different colored beam of light when ON;
a switch system electrically coupling said battery and said two LEDs to turn ON and OFF said LEDs;
said housing including a corresponding light modifier for each LED from the group of light modifiers including one or more light diffraction gratings and one or more light reflection surfaces, said corresponding light modifier scattering the respective beam of light from the corresponding LED when ON.

27. An underwater lighted fishing lure as claimed in claim 26 wherein one LED of said at least two LEDs emits a green light and the other LED emits either a blue light or a white light.

28. An underwater lighted fishing lure as claimed in claim 26 wherein one LED of said at least two LEDs emits a blue-green light and the other LED emits a white light.

29. An underwater lighted fishing lure as claimed in claim 26 wherein said switch includes a blinker circuit which causes said at least two LEDs to blink ON and OFF.

30. An underwater lighted fishing lure as claimed in claim 26 wherein said lure is adapted to be placed underwater subject to underwater current flows, said housing being generally elongated, and laterally extending fins on or about said elongated housing, said fins affected by said underwater current flows.

31. An underwater lighted fishing lure as claimed in claim 26 wherein said at least one battery is a battery power source selected from the group of battery power sources including two lithium batteries, three lithium batteries, four lithium batteries, three alkaline batteries, four alkaline batteries, and any battery power source supplying power to said LEDs at a voltage at or above 3.4 volts.

32. An underwater lighted fishing lure as claimed in claim 26 wherein said at least one battery is two, three or four batteries, and said at least two LEDs each have a recommended maximum current, said at least two, three or four batteries supplying current to said at least two LEDs at or exceeding 150% of said recommended current.

33. An underwater lighted fishing lure as claimed in claim 32 wherein said two, three or four batteries are lithium batteries.

34. An underwater lighted fishing lure as claimed in claim 26 wherein said housing retains two batteries and said batteries provide a supply voltage at or above 3.4 volts for said at least two LEDs.

36. An underwater lighted fishing lure as claimed in claim 34 wherein one LED of said at least two LEDs emits a green light and the other LED emits either a blue light or a white light.

37. An underwater lighted fishing lure subject to underwater current flows comprising:
two generally transparent, elongated housing units mounted side-by-side, each housing unit retaining a respective chemical luminescent light stick therein, each said chemical light stick being activated ON by mixing two chemicals which, when mixed, luminance, one light stick emitting color light from the group of colors comprising blue, green, blue-green and white and the other light stick emitting a different color light than said one light stick, said different color light being a color from the group of colors comprising blue, green, blue-green and white;
laterally extending fins on or about said elongated housing, said fins affected by said underwater current flows thereby causing the side-by-side mounted chemical light sticks to rotate underwater due to said underwater current flows and generating flashing colors when said light sticks are activated ON.

38. An underwater lighted fishing lure as claimed in claim 37 wherein one light stick emits a blue light and the other light stick emits either a green light or a white light.

39. An underwater lighted fishing lure as claimed in claim 37 wherein one light stick emits a blue-green light and the other light stick emits a white light.

40. An underwater lighted fishing lure subject to underwater current flows comprising:
two generally transparent, elongated housing units, each said housing unit retaining a respective chemical luminescent light stick therein, each said chemical light stick being activated ON by mixing two chemicals which, when mixed, luminance, said two chemicals being a first chemical contained in a first capsule and a second chemical contained in a second capsule which second capsule is retained within said first capsule;
said two housing units each having a free end portion and a mounted end portion;
a support rib joining said two housing units together in a spaced-apart relationship along respective mounted end portions, said support rib spacing said two housing units apart at respective free end portions such that when said free end portions flex, respective second capsules break, thereby mixing said first and second chemicals and activating respective light sticks ON.

41. An underwater lighted fishing lure as claimed in claim 40 wherein one light stick emits a blue light and the other light stick emits either a green light or a white light.

42. An underwater lighted fishing lure as claimed in claim 40 wherein one light stick emits a blue-green light and the other light stick emits a white light.

43. A clip for attaching an underwater lighted fishing lure to a line comprising an elongated generally rectangular O-shaped body having a base, two opposing elongated sides and a fore end, a U-shaped clip at said fore end, said U-shaped clip defining a mouth at a clip fore end of said U-shaped clip, a throat behind said mouth and a capture space within the U-shaped clip, said mouth having at least one tooth at said throat, said U-shaped clip keeping said tooth closed at said mouth by spring action due to the U-shape of the U-shaped clip and capturing said line within said capture space.

44. A clip for attaching an underwater lighted fishing lure to a line as claimed in claim 43 wherein said rectangular O-shaped body spring loads said U-shaped clip such that upon application of lateral force at said opposing sides, said U-shaped clip opens and upon removal of said lateral force, said clip closes due to said spring action of said rectangular O-shaped body on said clip.

45. A clip as claimed in claim 43 wherein said tooth has a lateral dimension and said line has a cross-sectional dimension, the tooth's lateral dimension being at least one-half of the cross-sectional dimension of said line.

46. A clip as claimed in claim 43 including a flexible lanyard attached to said base of said O-shaped body, said flexible lanyard adapted to be attached to an underwater apparatus.
